(19) United States
(12) Patent Application Publication
(10) Pub. No.: US 2003/0011301 A1
(43) Pub. Date: Jan. 16, 2003

(54) ORGANIC ELECTROLUMINESCENT DEVICE AND METHOD FOR PRODUCING IT, AND ORGANIC ELECTROLUMINESCENT DISPLAY AND METHOD FOR PRODUCING IT

(76) Inventors: TATSUYA SASAOKA, KANAGAWA (JP); MITSUNOBU SEKIYA, KANAGAWA (JP); NAOKI SANO, KANAGAWA (JP); TETSUO NAKAYAMA, TOKYO (JP); TAKASHI HIRANO, KANAGAWA (JP); YASUHIRO CHIBA, KANAGAWA (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/419,248

(22) Filed: Oct. 15, 1999

(30) Foreign Application Priority Data
Oct. 22, 1998 (JP) P10 301024

(51) Int. Cl. H05B 33/00

(52) U.S. Cl. 313/506

(57) ABSTRACT

In conventional organic EL displays, a metal cathode is formed on an organic layer through vapor deposition. In these, therefore, the cathode is of a film having tensile stress and easily peels off from the organic layer to degrade the reliability of the organic EL displays. A novel organic EL device is provided, in which a film having no internal stress or having compression stress is formed for a second electrode or for a second electrode and a protective layer, on an organic layer at least including a light-emitting layer of an organic light-emitting material. Also provided is an organic EL display including a plurality of those organic EL devices.

### BACKGROUND OF THE INVENTION

1. Field of the Invention

The present invention relates to display devices, especially to an organic electroluminescent (EL) device and a method for producing it, and to an organic EL display and a method for producing it. Precisely, the invention relates to an organic EL device in which a film is so formed on the organic layer therein that its internal stress could be 0 (zero) or could run in the pressing direction to thereby prevent it from being peeled off from the organic layer, and to a method for producing the organic EL device, and also relates to an organic EL display and a method for producing it.

2. Description of the Related Art

An organic EL display comprises a large number of organic EL devices for pixels, in which voltage is applied to each organic EL device whereby electrons from the cathode run into the organic light-emitting layer while holes from the anode run thereinto, and those electrons and holes are recombined in the organic light-emitting layer to give light. With that mechanism therein, the organic EL display emits light.

As one example of the organic EL device to be in the organic EL display of that type, known is a single hetero-type organic EL device such as that illustrated in FIG. 1. As illustrated, the organic EL device comprises an anode 112 of a transparent electroconductive film of, for example, ITO (indium tin oxide), which is formed on a transparent substrate 111 of, for example, a glass substrate or the like. On the anode 112, formed are an organic layer 115 which is composed of a hole-transporting layer 113 and a light-emitting layer 114, and a cathode 116 of a metal of, for example, aluminium or the like, in that order.

In the organic EL device with the constitution as above, positive voltage is applied to the anode 112 and negative voltage is to the cathode 116, whereby the holes from the anode 112 pass through the hole-transporting layer 112 and reach the light-emitting layer 114 while the electrons from the cathode reach the light-emitting layer 114, and those holes and electrons are recombined in the light-emitting layer 114. The electron-hole recombination gives light having a predetermined wavelength, and the light runs out through the transparent substrate 111 in the direction as shown by the arrows.

Aligning a plurality of those organic EL devices, for example, in matrices gives an organic EL display with the constitution as above. One example of the organic EL display of that type is in FIG. 2, which shows an outline of the perspective view of it. As in FIG. 2, the organic EL display comprises a transparent substrate 121 with a plurality of transparent electrodes 122 formed thereon in stripes. An organic layer 125 (this is a laminate of a hole-transporting layer and a light-emitting layer) is formed on the transparent electrodes 122; and a plurality of cathodes 126 are thereon via the organic layer 125. The cathodes 126 are in stripes perpendicular to the transparent electrodes 122. In the structure illustrated, organic EL devices are formed in the site where the transparent electrodes 122 and the cathodes 126 cross each other.

Another example of a conventional organic EL display is in FIG. 3, which shows an outline of the perspective view of it. As in FIG. 3, the organic EL display comprises a transparent substrate 121 with a plurality of transparent electrodes 122 formed thereon in stripes. In this, organic layers 125a, 125b and 125c (these each are a laminate of a hole-transporting layer and a light-emitting layer) are formed on the transparent electrodes 122 in stripes perpendicular to the respective transparent electrodes 122; and cathodes 126 are formed on those organic layers 125a, 125b and 125c. The size of each cathode 126 is nearly the same as that of the underlying organic layer. In the structure illustrated, organic EL devices are formed in the site where the transparent electrodes 122 and the cathodes 126 cross each other. In this case, the organic layers 125a, 125b and 125c have light-emitting characteristics for any one of red (R), green (G) and blue (B), respectively, with which the organic EL display is for full-color or multi-color expression.

One example of producing the organic EL display of FIG. 3 is disclosed in Preprint for the 44th Applied Physics-Related Joint Forum, 1997, p. 1149 by K. Nagayama, T. Yahagi, H, Nakada, K. Yoshida, T. Watanabe & S. Miyaguchi; and Electronic Display Forum, '98, pp. 5-18 by H. Nakada (EIAJ/SEMI).

According to the disclosure, a transparent substrate is first prepared. Then, a transparent electrode film of, for example, ITO or the like is formed on the transparent substrate in a physical film-forming process of sputtering or the like. Next, the transparent electrode film is patterned into anode stripes through ordinary lithography and etching. Next, a negative resist for forming spacing walls is applied on the anode stripes, and patterned through lithography that comprises exposure, development and baking, thereby forming the intended spacing walls between the adjacent two of which stripes of an organic layer combined with a cathode are to be formed. Finally, the intended stripes of an organic layer combined with a cathode are formed between the adjacent spacing walls through vapor deposition, for which is used a deposition mask with openings in the necessary area.

Where full-color or multi-color displays are produced according to the method disclosed, organic layers are formed as follows: Organic layers for red (R) are first formed. Next, organic layers for green (G) and those for blue (B) are formed. Finally, a metal layer to be a cathode is formed on every organic layer through vapor deposition.

On the other hand, the organic EL display of FIG. 2 could be produced in a process comprising forming anode stripes on the substrate, followed by forming an organic layer entirely over the anode stripes. After the process, spacing walls are formed on the organic layer, and cathode stripes are formed between the adjacent spacing walls through vapor deposition.

However, while the cathode stripes of a metal layer are formed on the organic layer through vapor deposition, it is difficult to keep the substrate at a high temperature since the heat resistance of the organic layer is low. Therefore, in forming the metal layer for the cathode stripes through vapor deposition, the temperature of the substrate shall be around 60° C. or lower. As a result, the cathode film to be formed through vapor deposition is to have tensile stress. In that condition, the cathode 126 is warped in concavity, as in FIG. 4, and its edge is peeled off from the organic layer 125 formed on the transparent electrode 122. Though not shown, owing to the tensile stress from the cathode to the organic layer, both the cathode and the organic layer are further warped in concavity, whereby the edge of the organic layer will be peeled off from the transparent electrode.

In particular, in producing full-color or multi-color displays, the organic layer 125 and the cathode 126 must be formed separately for red (R), green (G) and blue (B). In other words, the step of forming the organic layer 125 and the cathode 126 is repeated three times for those R, G and B. In the step, the developer used and even the solvent for the resist used will penetrate into the cathode 126, whereby the cathode 126 will become more readily peeled off.

If the cathode 126 of a metal layer is peeled off as described above, the light-emitting capabilities of the display will be degraded, and the display could not emit light uniformly through the entire surface of its panel. In that condition, the quality of the organic EL display is not good.

### SUMMARY OF THE INVENTION

The present invention is to solve the problems noted above, and is to provide an improved organic EL device and a method for producing it, and also an improved organic EL display and a method for producing it.

Specifically, the invention provides an organic EL device which comprises a film as formed on an organic layer at least having a light-emitting layer of an organic light-emitting material and in which the film has no internal stress or has compression stress.

In the organic EL device which comprises a film as formed on an organic layer at least having a light-emitting layer of an organic light-emitting material and in which the film has no internal stress or has compression stress, the film having no internal stress or having compression stress hardly peels off from the organic layer generally having extremely small stress.

The invention also provides a method for producing an organic EL device, which comprises a step of forming a film having no internal stress or having compression stress on an organic layer at least having a light-emitting layer of an organic light-emitting material.

According to the method for producing an organic EL device, which comprises a step of forming a film having no internal stress or having compression stress on an organic layer at least having a light-emitting layer of an organic light-emitting material, the film formed to have no internal stress or have compression stress hardly peels off from the organic layer generally having extremely small stress.

The invention still provides an organic EL display which comprises a plurality of organic EL devices and in which a film having no internal stress or having compression stress is formed on the organic layer at least having a light-emitting layer of an organic light-emitting material in each organic EL device.

In the organic EL display which comprises a plurality of organic EL devices and in which a film having no internal stress or having compression stress is formed on the organic layer at least having a light-emitting layer of an organic light-emitting material in each organic EL device, the film having no internal stress or having compression stress hardly peels off from the organic layer generally having extremely small stress.

The invention further provides a method for producing an organic EL display comprising a plurality of organic EL devices, and the method comprises a step of forming a film having no internal stress or having compression stress on an organic layer at least having a light-emitting layer of an organic light-emitting material in preparing a plurality of organic EL devices.

According to the method for producing an organic EL device comprising a plurality of organic EL devices, which comprises a step of forming a film having no internal stress or having compression stress on an organic layer at least having a light-emitting layer of an organic light-emitting material in preparing a plurality of organic EL devices, the film formed to have no internal stress or have compression stress hardly peels off from the organic layer generally having extremely small stress.

### BRIEF DESCRIPTION OF THE DRAWINGS

FIG. 1 a graphical cross-sectional view showing the constitution of a conventional, single hetero-type organic EL device.

FIG. 2 is a graphical perspective view showing the constitution of a conventional organic EL display.

FIG. 3 is a graphical perspective view showing the constitution of another conventional organic EL display.

FIG. 4 is a graphical cross-sectional view for explaining the problem that the invention is to solve.

FIG. 5 is a graphical cross-sectional view showing the constitution of the first embodiment of the organic EL device of the invention.

FIG. 6 is a graphical cross-sectional view showing the constitution of the second embodiment of the organic EL device of the invention.

FIG. 7 is a graphical cross-sectional view showing the constitution of the first embodiment of the method for producing an organic EL device of the invention.

FIG. 8 is a graphical cross-sectional view showing the constitution of the second embodiment of the method for producing an organic EL device of the invention.

FIG. 9 is a graphical perspective view showing the constitution of the first embodiment of the organic EL display of the invention.

FIG. 10 is a graphical perspective view showing the constitution of the second embodiment of the organic EL display of the invention.

FIG. 11 is a graphical perspective view showing the constitution of the first embodiment of the method for producing an organic EL display of the invention.

FIG. 12 is a graphical perspective view showing the constitution of the second embodiment of the method for producing an organic EL display of the invention.

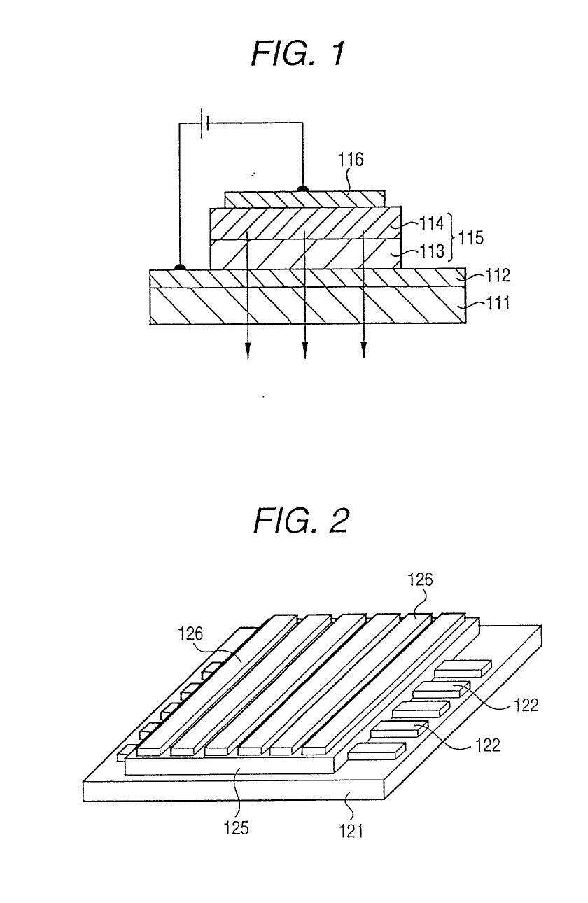

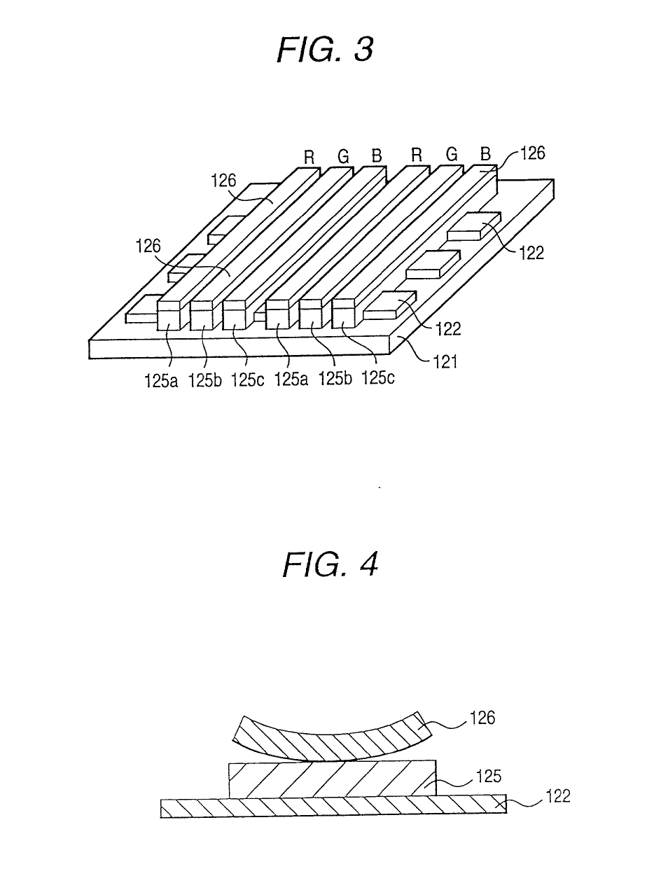

### DETAILED DESCRIPTION OF THE INVENTION

Embodiments of the organic EL device of the invention are described below.

The organic EL device comprises a first electrode of a transparent electrode formed on a transparent substrate, and an organic layer at least having a light-emitting layer of an organic light-emitting material and formed on the first electrode. In the organic EL device, a film having no internal stress or having compression stress is formed on the organic layer. The film having no internal stress or having compression stress comprises a second electrode or comprises a second electrode and a protective layer.

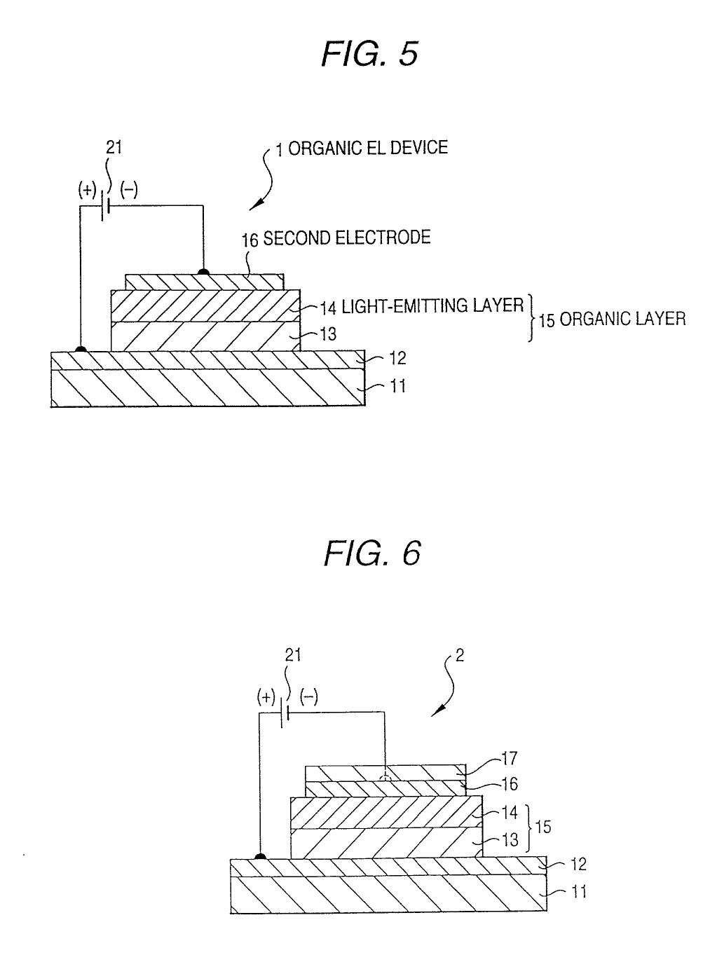

One embodiment of the organic EL device of the invention is described with reference to FIG. 5 which is a graphical cross-sectional view showing its constitution. FIG. 5 shows the first embodiment of the organic EL device comprises a film of a second electrode having no internal stress or having compression stress.

Precisely, as in FIG. 5, a first electrode (anode) 12 of a transparent electroconductive material having good light transmittance and electroconductivity, such as ITO, is formed on a transparent substrate 11 of glass. On the first electrode 12, formed is an organic layer 15 by laminating a hole-transporting layer 13 of an organic material and a light-emitting layer 14 of an organic light-emitting material in that order.

On the organic layer 15, formed is a film having no internal stress or having compression stress, which is for a second electrode (cathode) 16. The film of the second electrode 16 is of an electroconductive material such as, for example, aluminium, and is formed by sputtering such an electroconductive material onto the organic layer 15 in a high-vacuum (for example, not higher than 0.7 to 1.3 Pa) sputtering atmosphere.

In the illustrated embodiment, the first electrode 12 is connected with the positive pole (+) of a power 21, and the second electrode 16 is with the negative pole (−) thereof.

As illustrated, the organic EL device 1 is composed of the constituent elements.

In the organic EL device 1, the second electrode 16 is formed through aluminium sputtering in a high-vacuum atmosphere not higher than 0.7 to 1.3 Pa. Therefore, in this, the second electrode 16 is of a film having no internal stress or having compression stress. In addition, in this, since the second electrode 16 is formed on the organic layer 15 of an organic material generally having extremely small internal stress, the second electrode 16 hardly peels off from the organic layer 15. Accordingly, the organic EL device 1 has high reliability.

Next described is the second embodiment of the organic EL device of the invention with reference to FIG. 6 which is a graphical cross-sectional view showing its constitution. In this, a laminate of the second electrode with a protective layer formed thereon is of a film having no internal stress or having compression stress. In the second embodiment of FIG. 6, the same constituent elements as those in the first embodiment of FIG. 5 are designated by the same numeral references as in FIG. 5.

As shown in FIG. 6, a first electrode (anode) 12 of a transparent electroconductive material having good light transmittance and electroconductivity, such as ITO, is formed on a transparent substrate 11 of glass, like in FIG. 5. On the first electrode 12, formed is an organic layer 15 by laminating a hole-transporting layer 13 of an organic material and a light-emitting layer 14 of an organic light-emitting material in that order.

On the organic layer 15, formed is a film having no internal stress or having compression stress, which is for a second electrode (cathode) 16. The film of the second electrode 16 is of an electroconductive material such as, for example, aluminium, and is formed by sputtering such an electroconductive material onto the organic layer 15 in a high-vacuum (for example, not higher than 0.7 to 1.3 Pa) sputtering atmosphere. In addition, on the second electrode 16, further formed is a film having no internal stress or having compression stress, which is for a protective layer 17. The film of the protective layer 17 is formed through sputtering in a high-vacuum atmosphere of not higher than 0.7 to 1.3 Pa. Therefore, in this constitution, the laminate film of the second electrode 16 and the protective layer 17 shall have no internal stress or have compression stress.

In the illustrated embodiment, the first electrode 12 is connected with the positive pole (+) of a power 21, and the second electrode 16 is with the negative pole (−) thereof.

As illustrated, the organic EL device 2 is composed of the constituent elements.

In the organic EL device 2, the second electrode 16 is formed through aluminium sputtering in a high-vacuum (for example, not higher than 0.7 to 1.3 Pa) atmosphere. Therefore, in this, the second electrode 16 is of a film having no internal stress or having compression stress. Similarly, the protective layer 17 is also of a film having no internal stress or having compression stress. In addition, in this, since the second electrode 16 and the protective layer 17 are formed on the organic layer 15 of an organic material generally having extremely small internal stress, the second electrode 16 hardly peels off from the organic layer 15. Accordingly, the organic EL device 2 has high reliability.

Where the protective layer 17 is of a film having compression stress, it presses the edges of the second electrode 16 whereby the second electrode 16 is more effectively prevented from being peeled off from the organic layer 15.

In this embodiment where the laminate film composed of the second electrode 16 and the protective layer 17 has no internal stress or has compression stress, the second electrode 16 hardly peels off from the organic layer 15. Accordingly, in this embodiment, the second electrode 16 may have tensile stress while the protective layer 17 has compression stress, with the result that the laminate film of the two, second electrode 16 and protective layer 17, could have no internal stress or have compression.

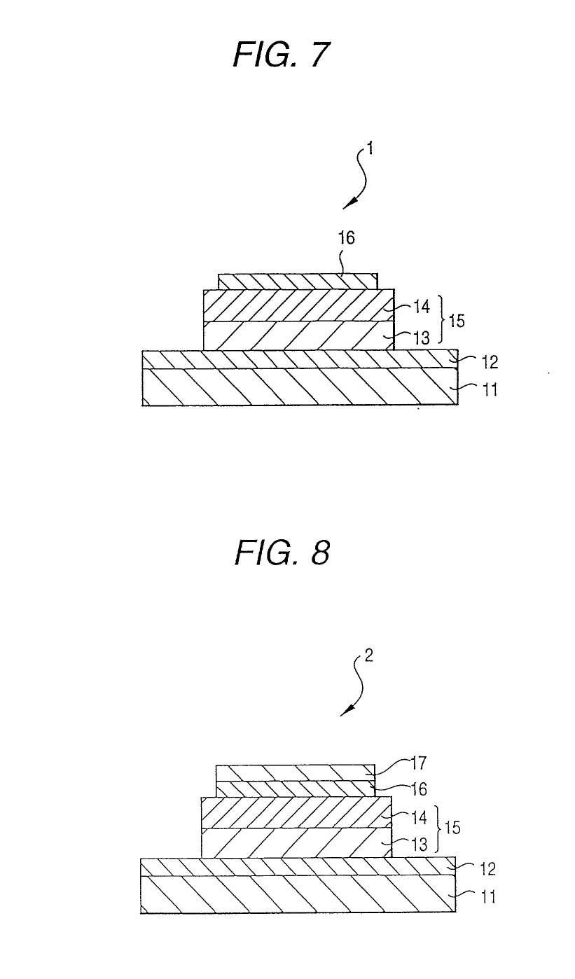

The first embodiment of the method for producing an organic EL device of the invention is described with reference to FIG. 7.

As in FIG. 7, a first electrode (anode) 12 of a transparent electroconductive material having good light transmittance and electroconductivity, such as ITO, is formed on a transparent substrate 11 of glass in a physical film-forming process of, for example, sputtering or the like. Next, according to a vacuum vapor deposition process in which is used a deposition mask (not shown), an organic layer 15 is formed on the first electrode 12 by laminating a hole-transporting layer 13 of an organic material and a light-emitting layer 14 of an organic light-emitting material in that order.

Next, according to a high-vacuum sputtering process in which is used a collimator (this is a mask having an aperture in the position that corresponds to the position in which a sputtering substance is deposited, but is not shown herein), a second electrode (cathode) 16 is formed on the organic layer 15. In the sputtering process, the sputtering atmosphere is controlled in vacuum, for example, not higher than 0.7 to 1.3 Pa, and a film of, for example, aluminium is formed having no internal stress or having compression stress for the second electrode 16. In this, argon may be used as the processing gas.

The method mentioned above is one example, in which, therefore, the means of forming the first electrode 12 and the organic layer 15 are not limited to the illustrated ones. Needless-to-say, these constituent elements may be formed in any other process (e.g., CVD, vapor deposition, sputtering, etc.).

For the second electrode 16, employable is any of tungsten, niobium, tantalum, titanium and the like, apart from aluminium as illustrated.

In the method for producing an organic EL device mentioned above, the second electrode 16 of a film having no internal stress or having compression stress is formed on the organic layer 15 of an organic material generally having extremely small internal stress. Therefore, the second electrode 16 formed hardly peels off from the organic layer 15.

The second embodiment of the method for producing an organic EL device of the invention is described with reference to FIG. 8.

As shown in FIG. 8, a first electrode 12 of a transparent electrode, an organic layer 15 composed of a hole-transporting layer 13 and a light-emitting layer 14, and a second electrode 16 are formed on a transparent substrate 11, in the same manner as in the first embodiment mentioned above.

Next formed is a protective layer 17 on the second electrode 16. In this case, the second electrode 16 and the protective layer 17 are formed so as to have no internal stress or have compression stress when laminated.

Briefly, the second electrode 16 is formed on the organic layer 15, for example, according to a high-vacuum sputtering process in which is used a collimator (this is a mask having an aperture in the position that corresponds to the position in which a sputtering substance is deposited, but is not shown herein). In the sputtering process, the sputtering atmosphere is controlled in vacuum, for example, not higher than 0.7 to 1.3 Pa, and a film of, for example, aluminium is formed having no internal stress or having compression stress for the second electrode 16. In this, argon may be used as the processing gas.

Similarly, the protective layer 17 is formed on the second electrode 16, for example, also according to a high-vacuum sputtering process in which is used a collimator (this is a mask having an aperture in the position that corresponds to the position in which a sputtering substance is deposited, but is not shown herein). In the sputtering process, the sputtering atmosphere is controlled in vacuum, for example, not higher than 0.7 to 1.3 Pa, and a film of, for example, tungsten is formed having no internal stress or having compression stress for the protective layer 17. In this, argon may be used as the processing gas.

The protective layer 17 may be made of any other material of, for example, aluminium, niobium, tantalum, titanium, silicon oxide or the like. It may also be made of silicon oxide, silicon nitride or the like in a plasma CVD process in which the CVD condition (including, for example, the film-forming temperature, the pressure for the film-forming atmosphere, the flow rate of the processing gas, etc.) is suitably controlled. In that manner, it is possible to form the intended protective film 17 having no internal stress or having compression stress.

In the method for producing an organic EL device mentioned above, the second electrode 16 and the protective layer 17 are so formed on the organic layer 15 that the laminate film of the two shall have no internal stress or have compression stress. Therefore, the second electrode 16 and the protective layer 17 formed thereon hardly peel off from the organic layer 15 generally having extremely small internal stress. Where the protective layer 17 is formed as a film having compression stress, it presses the edges of the second electrode 16 whereby the second electrode 16 is more effectively prevented from being peeled off from the organic layer 15.

In this embodiment where the laminate film composed of the second electrode 16 and the protective layer 17 has no internal stress or has compression stress, the second electrode 16 hardly peels off from the organic layer 15. Accordingly, in this embodiment, the second electrode 16 may be formed in any conventional vacuum vapor deposition process, while the protective layer 17 is formed to have compression stress in a high-vacuum sputtering process such as that mentioned above, with the result that the laminate film of the two, second electrode 16 and protective layer 17, could have no internal stress or have compression.

The organic EL display of the invention is described in detail hereinunder with reference to its embodiments.

The organic EL display comprises a transparent substrate with a plurality of transparent electrodes formed thereon in stripes, in which the transparent electrodes are the first electrodes for anodes. In this, organic layers (these each are a laminate of a hole-transporting layer and a light-emitting layer) are formed on the first electrodes also in stripes but perpendicular to the first electrodes; and a film having no internal stress or having compression stress is formed on each organic layer. The size of the film is nearly the same as that of the underlying organic layer. The film having no internal stress or having compression stress is for a second electrode for a cathode, or is composed of a second electrode for a cathode and a protective layer formed on the second electrode.

In the organic EL display, therefore, organic EL devices are formed in the site where the transparent electrodes and the cathodes cross each other. In this, the organic layers formed in stripes have light-emitting characteristics for any one of red (R), green (G) and blue (B), respectively, with which the organic EL display is for full-color or multi-color expression.

Some embodiments of the organic EL display of the invention are described below.

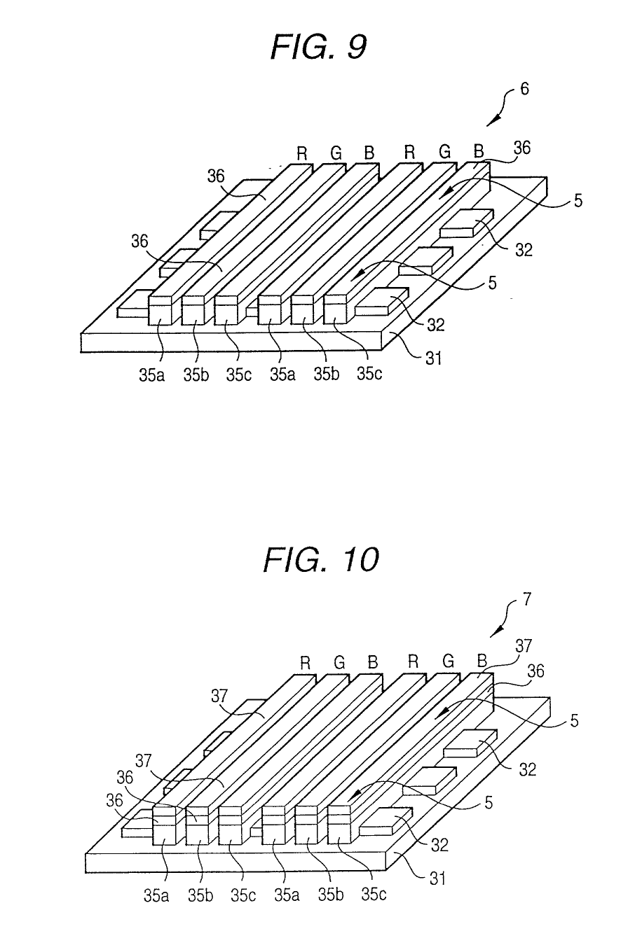

The first embodiment of the organic EL display is described with reference to FIG. 9 which is a graphical perspective view showing its constitution. In this, the second electrode is of a film having no internal stress or having compression stress.

As in FIG. 9, a plurality of first electrodes (anodes) 32 are formed in stripes on a transparent substrate 31 of glass, and each first electrode is of a transparent electroconductive material having good light transmittance and electroconductivity such as, for example, ITO. On these first electrodes 32, formed are organic layers 35a, 35b and 35c in stripes perpendicular to the transparent electrodes 32, and each organic layer is of a laminate composed of a hole-transporting layer and a light-emitting layer of an organic light-emitting material.

On each of these organic layers 35a, 35c and 35c, formed is a film having no internal stress or having compression stress, which is for a second electrode (cathode) 36. The film of the second electrode 36 is of an electroconductive material such as, for example, aluminium, and is formed by sputtering such an electroconductive material onto each organic layer in a high-vacuum (for example, not higher than 0.7 to 1.3 Pa) sputtering atmosphere. The size of the film is nearly the same as that of each organic layer 35a, 35b or 35c.

In the embodiment illustrated, therefore, organic EL devices 5 are formed in the site where the first electrodes 32 and the second electrodes 36 cross each other. In this, the organic layers 35a, 35b and 35c have light-emitting characteristics for any one of red (R), green (G) and blue (B), respectively, with which the organic EL display illustrated is for full-color or multi-color expression.

Though not shown, the first electrodes 32 are connected with a scanning circuit, and the second electrodes 36 are with a luminance signal circuit.

As illustrated, the organic EL display 6 is composed of the constituent elements.

In the organic EL display 6, the second electrodes 36 are formed through aluminium sputtering in a high-vacuum atmosphere not higher than 0.7 to 1.3 Pa. Therefore, in this, the second electrodes 36 are of a film having no internal stress or having compression stress. In addition, in this, since the second electrodes 36 are formed on the organic layers 35a, 35c and 35c of an organic material generally having extremely small internal stress, the second electrodes 36 hardly peel off from the organic layers 35a, 35b and 35c. Accordingly, the organic EL display 6 has high reliability.

Next described is the second embodiment of the organic EL display of the invention with reference to FIG. 10 which is a graphical perspective view showing its constitution. In this, a laminate of the second electrode with a protective layer formed thereon is of a film having no internal stress or having compression stress. In the second embodiment shown in FIG. 10, the same constituent elements as those in the first embodiment of FIG. 9 are designated by the same numeral references as in FIG. 9.

As shown in FIG. 10, a plurality of first electrodes (anodes) 32 of a transparent electroconductive material having good light transmittance and electroconductivity, such as ITO, are formed in stripes on a transparent substrate 31 of glass, like in FIG. 9. On these first electrodes 32, formed are organic layers 35a, 35b and 35c in stripes perpendicular to the transparent electrodes 32, and each organic layer is of a laminate composed of a hole-transporting layer and a light-emitting layer of an organic light-emitting material.

On each of these organic layers 35a, 35c and 35c, formed is a film having no internal stress or having compression stress, which is for a second electrode (cathode) 36. The film of the second electrode 36 is of an electroconductive material such as, for example, aluminium, and is formed by sputtering such an electroconductive material onto each organic layer in a high-vacuum (for example, not higher than 0.7 to 1.3 Pa) sputtering atmosphere. The size of the film is nearly the same as that of each organic layer 35a, 35b or 35c.

In addition, on each second electrode 36, further formed is a film having no internal stress or having compression stress, which is for a protective layer 37. The film of the protective layer 37 is formed through sputtering of an electroconductive material such as, for example, tungsten in a high-vacuum sputtering atmosphere of, for example, not higher than 0.7 to 1.3 Pa. The size of the protective layer 37 is nearly the same as that of the underlying second electrode 36.

In the embodiment illustrated, therefore, organic EL devices 5 are formed in the site where the first electrodes 32 and the second electrodes 36 cross each other. In this, the organic layers 35a, 35b and 35c have light-emitting characteristics for any one of red (R), green (G) and blue (B), respectively, with which the organic EL display illustrated is for full-color or multi-color expression.

Though not shown, for example, the first electrodes 32 are connected with a scanning circuit, and the second electrodes 36 are with a luminance signal circuit.

As illustrated, the organic EL display 7 is composed of the constituent elements.

In the organic EL display 7, the second electrodes 36 are formed through aluminium sputtering in a high-vacuum atmosphere not higher than 0.7 to 1.3 Pa. Therefore, in this, the second electrodes 36 are of a film having no internal stress or having compression stress. In addition, in this, the protective layers 37 are of a film having no internal stress or having compression stress. What is more, in this, since the second electrodes 36 and the protective layers 37 are formed on the organic layers 35a, 35c and 35c of an organic material generally having extremely small internal stress, the second electrodes 36 hardly peel off from the organic layers 35a, 35b and 35c. Accordingly, the organic EL display 7 has high reliability.

Where the protective layers 37 are of a film having compression stress, they presses the edges of the second electrodes 36 whereby the second electrodes 36 are more effectively prevented from being peeled off from the organic layers 35a, 35b and 35c.

In this embodiment where the laminate film composed of the second electrode 36 and the protective layer 37 has no internal stress or has compression stress, the second electrode 36 hardly peels off from the organic layer 35a, 35b or 35c. Accordingly, in this embodiment, the second electrode 36 may have tensile stress while the protective layer 37 has compression stress, with the result that the laminate film of the two, second electrode 36 and protective layer 37, could have no internal stress or have compression.

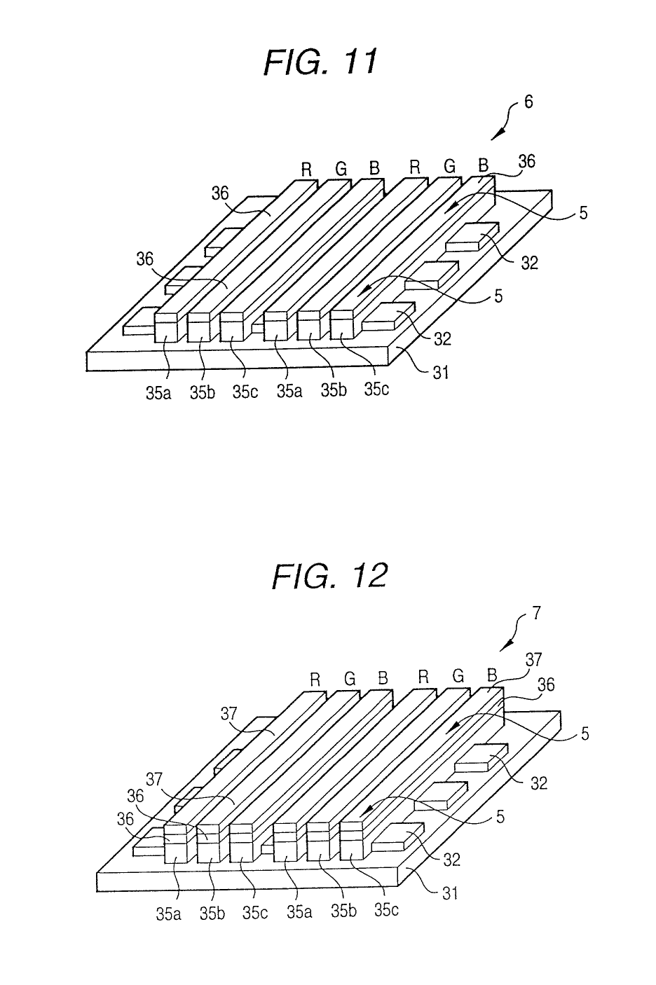

The first embodiment of the method for producing an organic EL display of the invention is described with reference to FIG. 11.

As in FIG. 11, a layer of a transparent electroconductive material having good light transmittance and electroconductivity, such as ITO, is formed on a transparent substrate 31 of glass, according to a physical film-forming process of, for example, sputtering or the like. Next, the layer of a transparent electroconductive material is patterned into a plurality of first electrodes (anodes) 32 in stripes, according to an ordinary lithographic or etching process.

Next, according to a vacuum vapor deposition process in which is used a deposition mask (not shown) with apertures formed therethrough in predetermined positions, a plurality of organic layers 35a for red (R) are formed in stripes on the first electrodes 32 in such a manner that the organic layers 35a are all perpendicular to the first electrodes 32. Each organic layer 35a is of a laminate of a hole-transporting layer and a light-emitting layer of an organic light-emitting material as laminated on the first electrode in that order. Similarly, a plurality of organic layers 35b for green (G) and organic layers 35c for blue (B) are formed in order, like the organic layers 35a.

For forming the organic layers 35a, 35b and 35c through vacuum vapor deposition, different deposition masks may be used for each color of those layers. Alternatively, the same deposition mask may be used for forming them, by suitably moving it for each color layer. Accordingly, the organic layers 35a, 35b and 35c are independently and separately formed for each color.

Next, according to a high-vacuum sputtering process in which is used a collimator (this is a mask having apertures formed therethrough in predetermined positions that correspond to the positions of the organic layers 35a, 35b and 35c, but is not shown herein), second electrodes (cathodes) 36 are formed on the organic layers 35a, 35b and 35c. The size of each second electrode 36 is nearly the same as that of each organic layer 35a, 35b or 35c that underlies the electrode 36. In the sputtering process, the sputtering atmosphere is controlled in vacuum, for example, not higher than 0.7 to 1.3 Pa, and a film of, for example, aluminium is formed having no internal stress or having compression stress for each second electrode 36. In this, argon may be used as the processing gas.

Accordingly, in the method of this embodiment, formed are organic EL devices 5 in the site where the first electrodes 32 and the second electrodes 36 cross each other. In this, the organic layers 35a, 35b and 35c have light-emitting characteristics for any one of red (R), green (G) and blue (B), respectively, with which the organic EL display is for full-color or multi-color expression.

In the manner as above, produced is the organic EL display 6.

The method mentioned above is one example, in which, therefore, the means of forming the first electrodes 32 and the organic layers 35a, 35b and 35c are not limited to the illustrated ones. Needless-to-say, these constituent elements may be formed in any other process (e.g., CVD, vapor deposition, sputtering, etc.).

For the second electrodes 36, employable is any of tungsten, niobium, tantalum, titanium and the like, apart from aluminium as illustrated.

In the method for producing an organic EL display mentioned above, the second electrodes 36 of a film having no internal stress or having compression stress are formed on the organic layers 35a, 35b and 35c of an organic material generally having extremely small internal stress. Therefore, the second electrodes 36 formed hardly peel off from the organic layers 35a, 35b and 35c.

The second embodiment of the method for producing an organic EL display of the invention is described with reference to FIG. 12, in which a laminate of the second electrode with a protective layer formed thereon is of a film having no internal stress or having compression stress. In the second embodiment of FIG. 12, the same constituent elements as those in the first embodiment of FIG. 11 are designated by the same numeral references as in FIG. 11.

As shown in FIG. 12, a plurality of first electrodes (anodes) 32 are formed in stripes on a transparent substrate 31 of glass, in the same manner as in the first embodiment of producing an organic EL display mentioned above. Next formed are a plurality of organic layers 35a for red (R) in stripes on the first electrodes 32 in such a manner that the organic layers 35a are all perpendicular to the first electrodes 32. Each organic layer 35a is of a laminate of a hole-transporting layer and a light-emitting layer of an organic light-emitting material as laminated on the first electrode in that order. Similarly, a plurality of organic layers 35b for green (G) and organic layers 35c for blue (B) are formed in order, like the organic layers 35a.

Next, according to a high-vacuum sputtering process in which is used a collimator (this is a mask having apertures formed therethrough in predetermined positions that correspond to the positions of the organic layers 35a, 35b and 35c, but is not shown herein), second electrodes (cathodes) 36 are formed on the organic layers 35a, 35b and 35c. The size of each second electrode 36 is nearly the same as that of each organic layer 35a, 35b or 35c. In the sputtering process, the sputtering atmosphere is controlled in vacuum, for example, not higher than 0.7 to 1.3 Pa, and a film of, for example, aluminium is formed having no internal stress or having compression stress for each second electrode 36. In this, argon may be used as the processing gas.

Next, according to a high-vacuum sputtering process in which is used a collimator (this is a mask having apertures formed therethrough in predetermined positions that correspond to the positions of the organic layers 35a, 35b and 35c, but is not shown herein), protective layers 37 are formed on every second electrode 36. The size of each protective layer 37 is nearly the same as that of each underlying second electrode 36. In the sputtering process, the sputtering atmosphere is controlled in vacuum, for example, not higher than 0.7 to 1.3 Pa, and a film of, for example, tungsten is formed having no internal stress or having compression stress for each protective film 37. In this, argon is used as one example of the processing gas.

Accordingly, in the method of this embodiment, formed are organic EL devices 5 in the site where the first electrodes 32 and the second electrodes 36 cross each other. In this, the organic layers 35a, 35b and 35c have light-emitting characteristics for any one of red (R), green (G) and blue (B), respectively, with which the organic EL display is for full-color or multi-color expression.

In the manner as above, produced is the organic EL display 7.

The method mentioned above is one example, in which, therefore, the means of forming the first electrodes 32 and the organic layers 35a, 35b and 35c are not limited to the illustrated ones. Needless-to-say, these constituent elements may be formed in any other process (e.g., CVD, vapor deposition, sputtering, etc.).

For the second electrodes 36 having no internal stress or having compression stress, employable is any of tungsten, niobium, tantalum, titanium and the like, apart from aluminium as illustrated. For the protective layers 37 having no internal stress or having compression stress, employable is any of silicon oxide, silicon nitride, aluminium or the like, apart from tungsten.

In the method for producing an organic EL display mentioned above, the second electrodes 36 and the protective layers 37 are so formed on the organic layers 35a, 35b and 35c of an organic material generally having extremely small internal stress that every laminate film of the two, second electrode 36 and protective layer 37 shall have no internal stress or have compression stress. Therefore, in this, the second electrodes 36 formed hardly peel off from the organic layers 35a, 35b and 35c. Accordingly, the organic EL display 7 formed in the method could have high reliability.

Where the protective layers 37 are of a film having compression stress, they presses the edges of the second electrodes 36 whereby the second electrodes 36 are more effectively prevented from being peeled off from the organic layers 35a, 35b and 35c.

In this embodiment where the laminate film composed of the second electrode 36 and the protective layer 37 has no internal stress or has compression stress, the second electrode 36 hardly peels off from the organic layer 35a, 35b or 35c. Accordingly, in this embodiment, the second electrodes 36 may be made of a material having tensile stress while the protective layers 37 are made of a material having compression stress, with the result that the laminate film of the two, second electrode 36 and protective layer 37, could have no internal stress or have compression.

For the organic EL display of the invention, color displays have been described hereinabove as embodiments of the invention. Naturally and needless-to-say, the constitution of the invention is applicable also to monochromatic displays, in which a film having no internal stress or having compression stress for a second electrode or for a laminate structure of a second electrode and a protective layer is formed on an organic layer.

As has been described in detail herein above, the organic EL device of the invention comprises a film as formed on an organic layer at least having a light-emitting layer of an organic light-emitting material, and the film has no internal stress or has compression stress. In the organic EL device, therefore, the film hardly peels off from the organic layer generally having extremely small stress. Accordingly, the organic EL device in which the film of that type is for the electrode or for the electrode and the protective layer has good quality and high reliability.

The method for producing an organic EL device comprises a step of forming a film having no internal stress or having compression stress on an organic layer at least having a light-emitting layer of an organic light-emitting material. According to the method, therefore, such a film having no internal stress or having compression stress may be formed for an electrode or for an electrode and a protective layer on an organic layer to produce an organic EL device. In the organic EL device thus produced, the film of that type for the electrode or for the electrode and the protective layer hardly peels off from the organic layer generally having extremely small internal stress. As a result, the organic EL device produced could have good quality and high reliability.

The organic EL display of the invention comprises a plurality of organic EL devices, in which a film having no internal stress or having compression stress is formed on the organic layer at least having a light-emitting layer of an organic light-emitting material in each organic EL device. Therefore, in the organic EL display, the film hardly peels off from the organic layer generally having extremely small stress. The organic EL display comprising a plurality of organic EL devices, in which the film of that type for electrodes or for electrodes or protective layers is formed on organic layers, has good quality and high reliability.

The method for producing an organic EL display of the invention comprises a step of forming a film having no internal stress or having compression stress on an organic layer at least having a light-emitting layer of an organic light-emitting material in preparing a plurality of organic EL devices for the display. According to the method, therefore, such a film having no internal stress or having compression stress may be formed for the electrode or for the electrode and the protective layer on the organic layer in every EL device constituting the display. In the organic EL display thus produced according to the method, the film of that type as formed for the electrode or for the electrode and the protective film on the organic layer generally having extremely small internal stress in every EL device hardly peels off from the organic layer. As a result, it is possible to produce an organic EL display having good quality and high reliability, according to the method of the invention. In the method, in addition, the step of forming the organic layer and the second electrode may be repeated. Therefore, according to the method, it is possible to produce a full-color or multi-color, organic EL display having good quality and high reliability.

While the invention has been described in detail and with reference to specific embodiments thereof, it will be apparent to one skilled in the art that various changes and modifications can be made therein without departing from the spirit and scope thereof.

What is claimed is:

1. A light-emitting device comprising;
a substrate,
a first electrode formed on said substrate,
a light-emitting layer formed on said first electrode, and
a second electrode formed on said light-emitting layer, wherein;
said second electrode has no internal stress or has compression stress.

2. The light-emitting device as claimed in claim 1, wherein said light-emitting layer is of an organic substance.

3. The light-emitting device as claimed in claim 2, which has a hole-transporting layer of an organic substance between said first electrode and said light-emitting layer.

4. The light-emitting device as claimed in claim 1, which has a protective layer on said second electrode and in which said protective layer has no internal stress or has compression stress.

5. The light-emitting device as claimed in claim 1, which has a protective layer on said second electrode and in which the combination of said protective layer and said second electrode has no internal stress or has compression stress.

6. The light-emitting device as claimed in claim 1, which has a protective layer on said second electrode and in which said second electrode has tensile stress while said protective layer has compression stress with the combination of said protective layer and said second electrode having no internal stress or having compression stress.

7. The light-emitting device as claimed in claim 4, wherein said protective layer is made of tungsten or of any material of silicon nitride, silicon oxide or aluminium.

8. A light-emitting device comprising;
a transparent substrate,
a first electrode of a transparent electroconductive material formed on said transparent substrate,
a light-emitting layer of an organic material formed on said first electrode, and
a second electrode formed on said light-emitting layer, wherein;
said second electrode has no internal stress or has compression stress.

9. The light-emitting device as claimed in claim 8, which has a hole-transporting layer of an organic substance between said first electrode and said light-emitting layer.

10. The light-emitting device as claimed in claim 8, which has a protective layer on said second electrode and in which said protective layer has no internal stress or has compression stress.

11. The light-emitting device as claimed in claim 8, which has a protective layer on said second electrode and in which the combination of said protective layer and said second electrode has no internal stress or has compression stress.

12. The light-emitting device as claimed in claim 8, which has a protective layer on said second electrode and in which said second electrode has tensile stress while said protective layer has compression stress with the combination of said protective layer and said second electrode having no internal stress or having compression stress.

13. A display device comprising a light-emitting device, wherein said light-emitting device comprises;
a transparent substrate,
a first electrode of a transparent electroconductive material formed on said transparent substrate,
a light-emitting layer formed on said first electrode, and
a second electrode formed on said light-emitting layer, and wherein;
said second electrode has no internal stress or has compression stress.

14. The display device as claimed in claim 13, wherein said light-emitting layer is of an organic substance.

15. The display device as claimed in claim 14, which has a hole-transporting layer of an organic substance between said first electrode and said light-emitting layer.

16. The display device as claimed in claim 13, which has a protective layer on said second electrode and in which said protective layer has no internal stress or has compression stress.

17. The display device as claimed in claim 13, which has a protective layer on said second electrode and in which the combination of said protective layer and said second electrode has no internal stress or has compression stress.

18. The display device as claimed in claim 13, which has a protective layer on said second electrode and in which said second electrode has tensile stress while said protective layer has compression stress with the combination of said protective layer and said second electrode having no internal stress or having compression stress.

19. The display device as claimed in claim 13, wherein said first electrode is formed in stripes on said transparent substrate, said light-emitting layer is formed on said first electrode, and said second electrode is formed on said light-emitting layer both in stripes nearly perpendicular to the stripes of said first electrode.

20. The display device as claimed in claim 13, wherein said first electrode is formed in stripes on said transparent substrate, said light-emitting layer is formed on said first electrode, and said second electrode is formed on said light-emitting layer along with a protective layer that overlies said second electrode, all in stripes nearly perpendicular to the stripes of said first electrode, and wherein the combination of said protective layer and said second electrode has no internal stress or has compression stress.
